(19) United States
(12) Patent Application Publication
(10) Pub. No.: US 2026/0261852 A1
(43) Pub. Date: Sep. 3, 2026

(54) MECHANISMS FOR A1 FILTERING, ANONYMIZATION, AND DE-ANONYMIZATION IN WIRELESS NETWORKS

(71) Applicant: INTERDIGITAL PATENT HOLDINGS, INC., Wilmington, DE (US)

(72) Inventors: Antonio DE LA OLIVA, Madrid (ES); Joseph LEVY, Merrick, NY (US); Robert GAZDA, Spring City, PA (US); Rui YANG, Melville, NY (US)

(21) Appl. No.: 19/163,431

(22) PCT Filed: Mar. 8, 2024
(86) PCT No.: PCT/US2024/019055

§ 371 Date: Sep. 9, 2025

Related U.S. Application Data
(60) Provisional application No. 63/489,599, filed on Mar. 10, 2023.

(51) Int. Cl. H04W 12/06; H04L 5/00; H04W 12/69

(52) U.S. Cl. CPC H04W 12/06; H04L 5/0053; H04W 12/69

(57) ABSTRACT

An association and authentication medium access control (aaMAC) address is assigned a station (STA) during association with an AP. STAs communicate initially using the aaMAC address and may communicate subsequently using over-the-air MAC (otaMAC) addresses to maintain anonymity. Filtering techniques may be used to associate frames with active aaMAC addresses with temporary otaMAC addresses that are exchanged between nodes using Active MAC Address Set Request and Response frames. A STA sends a frame to a node (e.g., STA2) using an association and aaMAC address associated with the STA and sends a first active MAC address set request to the node including an otaMAC address for wireless transmissions from the STA. The reciprocal process is performed by STA2, and subsequent communications may be exchanged between STAs using the otaMAC addresses and/or the aaMAC addresses randomly to enhance privacy.

### CROSS REFERENCE TO RELATED APPLICATIONS

This application claims the benefit of U.S. provisional patent application No. 63/489,599 filed 10 Mar. 2023, which is incorporated by reference herein in its entirety.

### BACKGROUND

User privacy is compromised when a user can be tracked in a public space. In wireless local area networks (WLANs), the current use of a fixed medium access control (MAC) address for an associated non-access point (AP) station (STA) in an extended service set (ESS) or basic service set (BSS) allows for easy tracking of an individual non-AP STA in the coverage area of the ESS or BSS. If a user changes their MAC address to avoid being tracked, the user currently must reestablish their association with the ESS or BSS requiring the user to reidentify themselves, establish a new security context (new security keys) and be assigned a new IP address. While this will reduce the ability of the user to be tracked during its association with the ESS or BSS, it is done at a considerable overhead (OH) cost of having to reestablish their association each time. Allowing a non-AP STA to frequently change its MAC address (and/or any other trackable header content) without incurring the OH cost of having to reestablish its ID and security context is highly desirable, as it will increase non-AP STA privacy without causing network inefficiency.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example Active MAC Address Set Request element format;

FIG. 3 is an example Management Request field format;

FIG. 4 is an example Active MAC Address Set Response element format;

FIG. 5 is an example Management Response field format;

FIG. 6 is a message sequence diagram showing an example method for protecting active MAC address in request and response frames in a WLAN according to one example embodiment;

FIG. 7 is an example Active MAC Address Set Request element to modify MAC addresses of a dot11ActiveMACAddressesSet associated to the transmitting aaMAC and stored in the receiving station;

FIG. 8 is an example Management Request field format for the element of FIG. 7;

FIG. 9 is an example Active MAC Address Set Response element format used to signal a result of a management operation including a Transmitting aaMAC field and a Status field;

FIG. 10 is an example Status field format of the element of FIG. 9;

FIG. 11 is a message sequence diagram showing an example method for protecting active MAC address in address set and response frames according to an example embodiment; and

FIG. 12 is an example flow diagram of a method according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

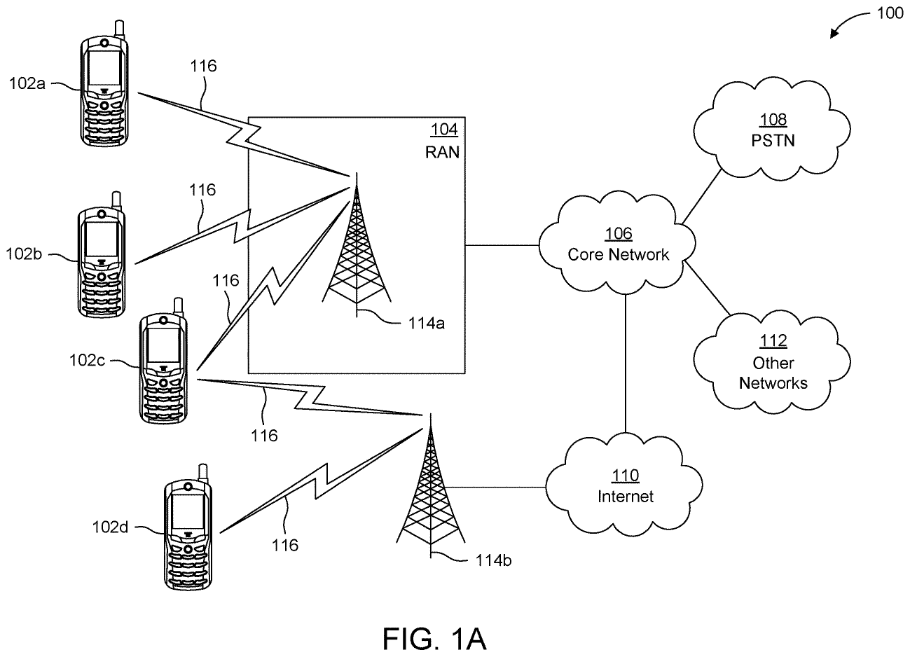

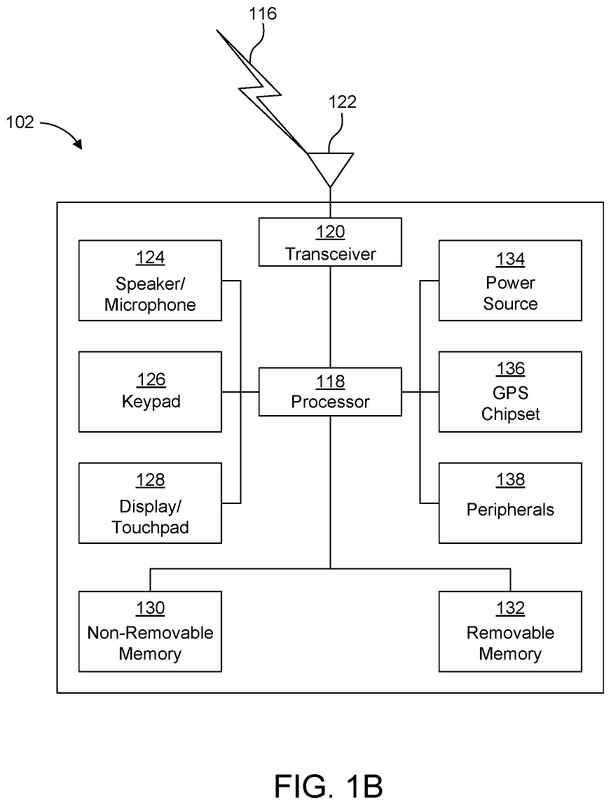

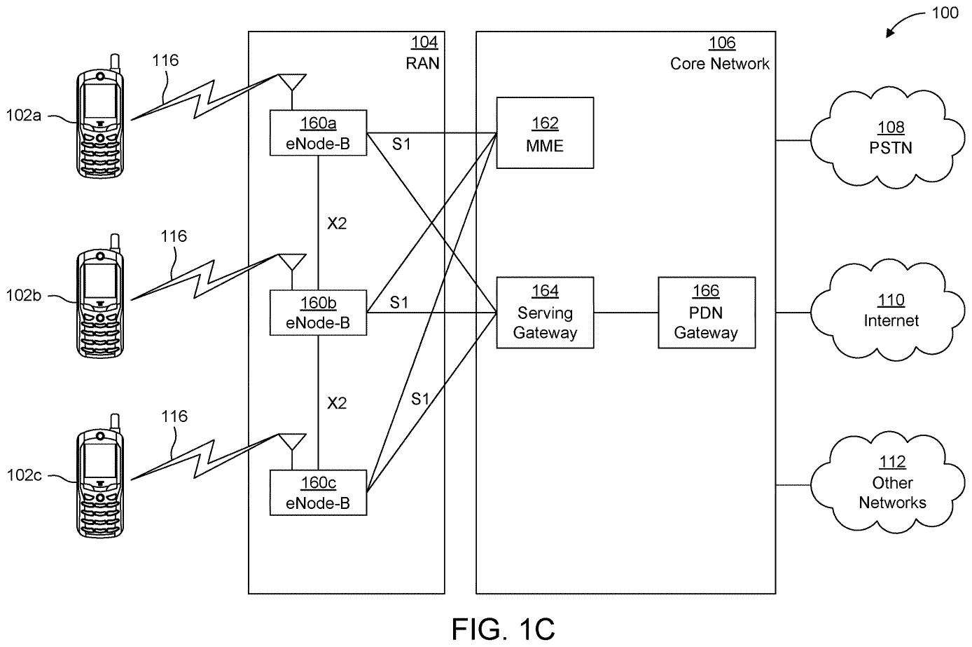

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHZ, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### MAC Privacy Enhancements

IEEE 802.11 has seen a trend in the last years towards providing new mechanisms for the protection of the privacy of individuals using WLAN technology. One of the main areas of work in this aspect in the last years has been protecting users from those who track them. This means protecting the possible identification of users as they roam to different locations and IEEE 802.11 or similar networks.

Several modifications to the baseline specification were introduced in IEEE 802.11aq to support the current MAC Privacy features. These features focus on protecting the privacy of the user in non-associated state. In the following the current state of the MAC Privacy enhancements in the baseline specification is described (note that the baseline specification is IEEE 802.11-2020) and new work is being pursued in the IEEE 802.11bi and IEEE 802.11bh specifications.

As described herein, the specifications IEEE 802.11-REVme/D2.0 and IEEE 802.11be/D2.3 are considered as a reference baseline for purposes of the discussion herein. However, the references IEEE 802.11-REVme/D2.0 and IEEE 802.11be/D2.3 are not to be considered a limitation to the innovations described herein.

Several characteristics of IEEE 802.11 can be used to track users. Prior to association to an AP, a STA defines the MAC address that it is going to use for the association. Before the MAC Privacy enhancements were added to the base line specification, a STA would use a fixed MAC address (usually the MAC address provided by the device manufacture) for all associations. This behavior made trivial the tracking of the STA, since just observing the MAC address in pre-association messages, allow the tracking and identification of the STA. The added base line specification for MAC Privacy enhancements allowed for the fixed MAC address to be changed to a random MAC address, known as Random and Changing MAC address (RCM). This increased user privacy by removing this simple technique for tracking STAs. However, it also required that the STA maintain its MAC address while the STA was associated with the network, allowing the associated STA to be tracked.

In addition to the MAC address, there are other mechanisms that can be used to track an associated STA in IEEE 802.11. For example, each frame in the communication has a sequence number (SN) associated. Even if the STA MAC address changes during an association, this sequence number can be used to track the STA, since consecutive frames will show consecutive sequence numbers. Some other mechanisms are more complex, such as the OFDM PHY DATA scrambler, which can also be tracked if not reseeded.

The MAC Privacy enhancements previously introduced in the standard enabled the STA to modify all these parameters in the pre-association state, in such a way that a user cannot be trivially tracked while it roams before associating to a network or while it changes network access.

As indicated in the standard, the MAC Privacy enhancements “mitigate this sort of traffic analysis a STA can support the ability to periodically and randomly change its MAC addresses and reset counters and seeds prior to association. While discovering networks, a STA can refrain from gratuitously transmitting Probe Request frames containing SSIDs of favored BSS networks.”

### Requirements for Support of MAC Privacy Enhancements

The baseline specification defines a set of requirements for applying MAC address randomization including:
The STA may periodically change its MAC address to a random value while not associated to a BSS;
The STA may construct the randomized MAC address from the locally administered address space as defined in IEEE Std 802-2014 and IEEE Std 802c-2017;
The non-AP STA may not change its MAC address during a transactional exchange, for example, transmitting Public Action frames for pre-association discovery, or during the creation of state on an AP using pre-association capabilities, for example, RSN pre-authentication or FT over-the-DS;
If a non-AP STA starts any transaction that establishes state bound to a MAC address and decides to establish an association or a transaction state with a discovered BSS, it may change the MAC address to the one used to establish this state;
State created with an AP using a prior MAC address, for instance, robust secure network (RSN) pre-authentication state or fast transition (FT) state established over-the-DS, is bound to the MAC address used when that state was created; and
Every time a MAC address is changed to a new random value in unassociated state, counters in all sequence number spaces used to identify each frame must be reset.

The non-AP STA connecting to an infrastructure BSS may retain a single MAC address for the duration of its connection across an ESS, as the security association between the AP/ESS and the STA is linked to the MAC address. If the non-AP STA wishes to change its MAC address it must reestablish the security association (identification, IP address, and security keys) every time it changes its MAC address.

Although the currently specified MAC Privacy enhancements highly improve the privacy of the user, it has proven to be insufficient in providing an acceptable level of user privacy (i.e., associated users can be easily tracked as they move through a public space due to their fixed MAC address). Due to this, the IEEE 802.11 created the RCM study group to study enhancements to user privacy and how to improve the operation of networks where MAC address randomization is used.

The RCM study group concluded its operation in 2020 and two Project Authorization Requests (PARs) were created and accepted which in turn created two 802.11 Task Groups: (i) IEEE 802.11bi: Enhanced Service with Data Privacy Protection; and (ii) IEEE 802.11bh: Operation with Randomized and Changing MAC Addresses.

IEEE 802.11bi focus is to specify modifications to the IEEE Std 802.11 MAC to include new mechanisms that address and improve user privacy.

IEEE 802.11bh focus is to specify modifications to the MAC mechanisms to preserve the existing services that might otherwise be restricted in environments where STAs use RCM, without degrading the user privacy gains provided by RCM. IEEE 802.11bh will work on mechanisms to enable session continuity in the absence of any unique MAC address-to-STA mapping.

As mentioned previously, user privacy is compromised when a user can be tracked in a public space. The current use of a fixed MAC address for an associated non-AP STA in an ESS or BSS allows for easy tracking of an individual non-AP STA in the coverage area of the ESS or BSS. If a user changes their MAC address to avoid being tracked the user currently must reestablish their association with the ESS or BSS requiring the user to reidentify themselves, establish a new security context (new security keys) and be assigned a new IP address. While this will reduce the ability of the user to be tracked during its association with the ESS or BSS, it is done at a considerable overhead (OH) cost of having to reestablish their association each time. Allowing a non-AP STA to frequently change its MAC address (and any other trackable header content) without incurring the OH cost of having to reestablish its ID and security context is highly desirable, as it will increase non-AP STA privacy without causing network inefficiency.

Embodiments described herein relate to methods, devices and message formats to enable A1 address filtering while communicating STAs change their MAC addresses. In addition, and in order to improve the privacy, embodiments may include hiding the sequence number of the frame, for example, obfuscating the sequence number based on the set of addresses used in the frame.

### Definitions

According to various embodiments, two medium access control (MAC) definitions are provided including an association and authentication MAC (aaMAC) address and an over-the-air MAC (otaMAC) address. The aaMAC address corresponds to the MAC address used for the association and authentication process between the AP and the STA and is the one indexed in the RSNA (Robust Secure Network Association). This MAC address is used to set up the RSNA, for routing traffic to the STA on the DS network segment and it is also the one used for mobility related operations such as Fast Transition mechanisms. The otaMAC address is a temporal MAC address used in frames transmitted over the air. The Distribution System (DS) bits of the IEEE 802.11 frame indicate the direction of transmission. For individually addressed frames where the To DS bit is set=1 and the From DS bit is set=0, the otaMAC is transmitted as the Address-2. For individually addressed frames where the To DS bit is set=0 and the From DS bit is set=1, the otaMAC is transmitted as the Address-1. A purpose for using the otaMAC is to keep private the aaMAC of the STA, and the otaMAC may potentially be changed on a packet basis.

Use of different sets of MAC addresses for each peer STA and direction of the communication may include filtering for anonymization and de-anonymization and/or messages to manage active MAC sets as described further below.

### Embodiment 1: Use of Different Sets of MAC Addresses for Each Peer STA and Direction of the Communication

### A1 Filtering and Anonymization/De-Anonymization

The modification of the MAC addresses used in a communication during association requires mechanisms to maintain a list of MAC addresses that may be used for the receiving and transmitting STAs. Modifying the MAC addresses impacts the A1 filtering and requires modifications in the MAC process. In one example innovative embodiment, an Anonymization and De-anonymization block is included in MAC processing. In this embodiment it is assumed each communicating STA pair may define a specific set of otaMAC addresses to be used as RX (A1) and TX (A2) addresses for each direction of the communication. This does not preclude using the same address or different addresses for both directions of the communication (i.e. UL and DL communication).

Each Enhanced Privacy (EP) STA maintains a record of the aaMAC used during the association (aaMAC STA) and each EP STA involved in the communication maintains a Tx Active MAC Address Set and a Rx Active MAC Address Set for each of the STAs to which it transmits or receives frames.

In one innovative embodiment, The Tx Active MAC Address Set may include two lists. The first list contains the mapping between the aaMAC of the peer STA (aaMAC_pSTA) and the list of addresses, selected by the peer STA and indicated to the STA, the peer STA receives frames (A1) from the STA (e.g., a list of otaMAC_pA1 addresses). The second list contains the mapping between the aaMAC of the peer STA (aaMAC_pSTA) and the list of addresses the STA may use to transmit frames to the peer STA (e.g., a list of otaMAC_A2 addresses). The Tx Active MAC Address is used on transmission of a frame to a peer STA.

In one innovative embodiment, the Rx Active MAC Address Set may also include two lists. The first list contains the mapping between the aaMAC of the peer STA (aaMAC_pSTA) and the list of addresses the STA may use to receive information from the peer STA (list of otaMAC_A1 addresses). The second list contains the mapping between the aaMAC of the peer STA (aaMAC_pSTA) and the list of addresses the peer STA may use, as Tx address, to transmit frames to the STA (list of otaMAC_pA2 addresses).

In various related embodiments, the pool of addresses used by a STA to receive frames from a peer STA (otaMAC_A1) and the pool of addresses used by an STA to send frames to a peer STA (otaMAC_A2) may be equal or different. Further, after signaling exchange, the Tx Active MAC Set of the transmitting STA and the Rx Active MAC Set of the receiving STA may be synchronized and store the same information. The Tx or Rx Active MAC Address Set therefore is dynamic and may change during a communication or association.

In one example method, the transmitting process starts by the anonymization process of the frame, given a Tx Active MAC Address Set stored in a STA, starts by the STA processing a MAC protocol data unit (MDPU) to be transmitted. It first compares the Rx (A1) address on the MPDU with the aaMAC pSTA stored in the different Tx Active MAC Address Sets. Once found, the transmitting STA may choose among all the otaMAC_pA1 addresses and all the otaMAC_A2 addresses in the identified Tx Active MAC Address Set. The MPDU is then modified, exchanging the A1 and A2 addresses by the newly selected otaMAC_pA1 and otaMAC_A2 and continue processing.

In an example method, the receiving process starts by the STA receiving a unicast frame and performing A1 filtering. The receiving STA compares the A1 address in the received frame to the list of otaMAC_A1 addresses stored in all the Rx Active MAC Address Sets. If found, processing may continue, otherwise the frame should be discarded. After checking A1, the Enhanced Privacy (EP) or Enhanced Data Privacy (EDP) receiving STA may check for the A2 address, comparing it to the otaMAC_pA2 addresses stored in the Rx Active MAC Address Set (note the receiving STA already knows the aaMAC_pSTA due to step 1). If found, the frame is modified, exchanging the A1 address by the aaMAC_pSTA of the transmitting STA (stored in the Rx Active MAC Address Set) and the A2 by the receiving aaMAC_STA (locally known).

Messages to Manage the Active MAC Sets for Use with Different Sets of MAC Addresses for Each Peer STA and Direction of Communication

Embodiments in this regard relate to the information that may be carried by a possible frame used to indicate the addition or removal of MAC addresses into the pool of active MAC addresses. The following specific frame/element/field formats are example implementations and implementations where similar information is carried in other kind of frames, elements or fields may also be used. The innovations herein may be standardized for use by STAs in wireless networks. As such, the innovations described below may be included in a wireless specification such as IEEE 802.11bi or other wireless specification.

In one innovative embodiment, Action frames are defined, for example, an Active MAC Address Set Management Request frame format. This frame enables the addition, removal, or request for the complete Active MAC Address Set. One Action frame example is for Public Action frames which may include fields/descriptions as shown in Table 1 below:

TABLE 1
Example Public Action Frames for Active MAC
Address Set Management Request and Response

| Public Action | |
|---|---|
| field value | Description |
| TBD | Active MAC Address Set Management |
| | Request |
| TBD | Active MAC Address Set Management |
| | Response |

These frames assist in the protection of frames exchanging the MAC sets. Such frames may be defined as Protected Public Action frames, but a different implementation may define them as another type of Protected Action frame. For example, a newly created category for protected Enhanced Privacy Action frames may be referred to as Robust Action frames (non-public).

Active MAC Address Set Management Request Frame Format: The Active MAC Address Set Management Request frame may be sent to a STA to manage the Active MAC Address Set associated to the transmitting STA stored in the receiving STA. The Action field of an Active MAC Address Set Management Request frame may contain the information shown in the following Table 2.

TABLE 2
Action Field Info of MAC Address
Set Management Request Frame

| Order | Information |
|---|---|
| 0 | Category |
| 1 | Public Action |
| 2 | Dialog Token |
| 3 | Active MAC Address Set Request |

The innovation herein includes an Active MAC Address Set Request field as described herein.

Active MAC Address Set Management Response Frame Format: The Active MAC Address Set Management Response frame is a reply to a requesting STA to indicate the status of a request for the managing of its Active MAC Address Set. In one embodiment, the Action field of an Active MAC Address Set Management Response frame may contain the information shown in the following Table

TABLE 3
Action Field Info of MAC Address
Set Management Response Frame

| Order | Information |
|---|---|
| 0 | Category |
| 1 | Public Action |
| 2 | Dialog Token |
| 3 | Active MAC Address Set Response |

The Active MAC Address Set Response is newly defined herein and serves the purposes and includes information as described herein. The information carried in the Active MAC Address Set element may be implemented in a different field. The following is an example of an implementation in an element field.

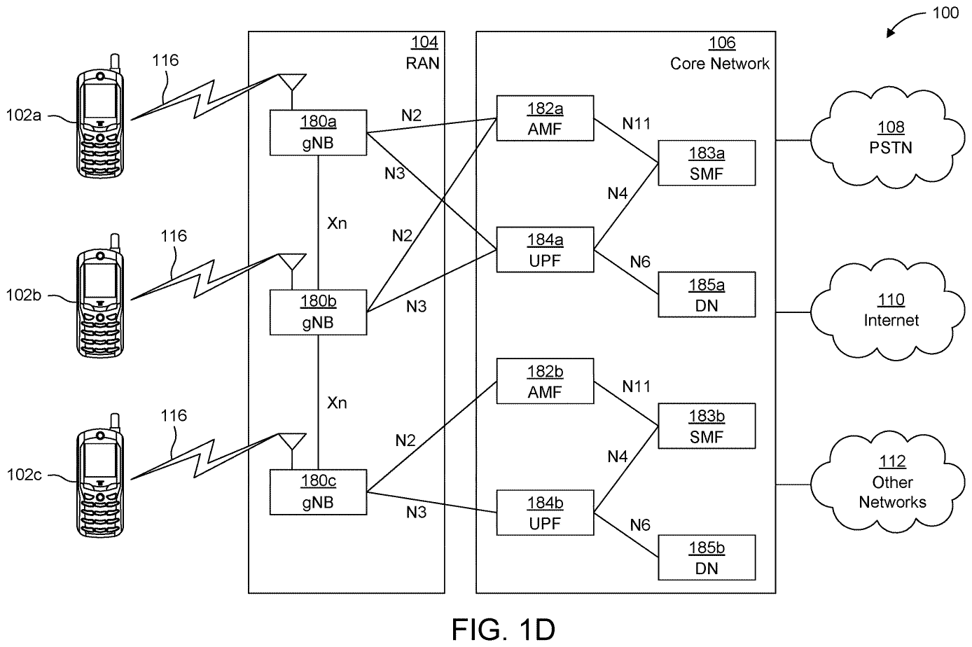

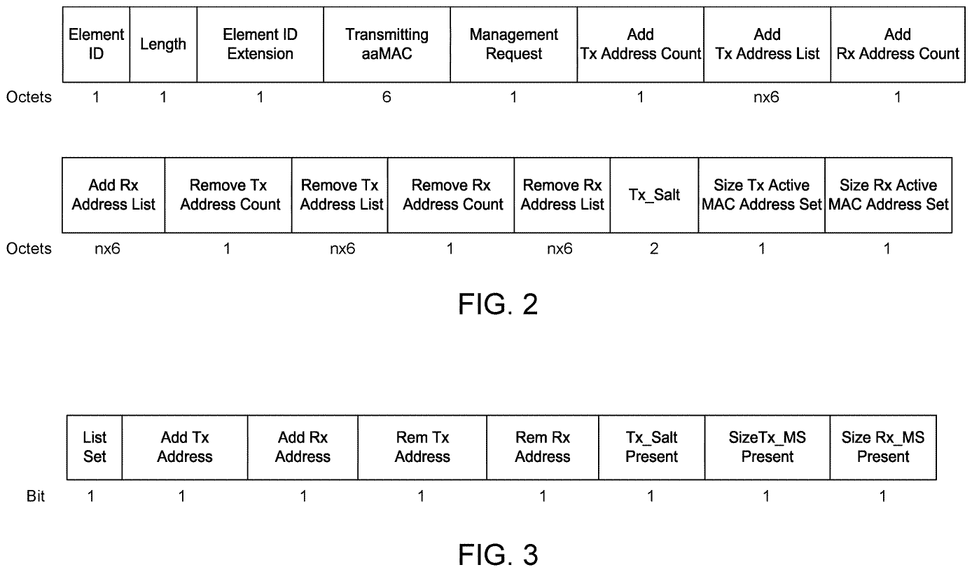

Active MAC Address Set Request: The Active MAC Address Set Request element is used to signal the desire to include, remove or list the MAC addresses belonging to the dot11ActiveMACAddressesSet associated to the transmitting aaMAC and stored in the receiving STA. An example format of an Active MAC Address Set Request element is shown in FIG. 2 and may generally include: Element ID, Length and Element ID Extension fields, a Transmitting aaMAC field, a Management Request field and other fields as shown.

The Transmitting aaMAC field includes the transmitting aaMAC_pSTA associated to the transmitting STA. Note that the transmitting MAC address (A2) of the frame carrying this element may be already included in the Rx Active MAC Address Set (otaMAC_pA2) associated to the transmitting aaMAC (aaMAC_pSTA) on the receiving STA.

Referring to FIG. 3, an example format for a Management Request field of the MAC Address Set Request element of FIG. 2 is shown. In certain embodiments, the format of the Management Request field may include one or more of the following indicators and/or purposes:
List Set bit, when set to 1, indicates the request to list the addresses in the Active MAC Address Sets. Otherwise indicates the transmitter is not requesting the receiver to list its Active MAC Address Sets.
Add Tx Address bit=1 indicates the Add Tx Address Count and Add Tx Address List fields are present in the Active MAC Address Set Request element.
Add Rx Address bit=1 indicates the Add Rx Address Count and Add Rx Address List fields are present in the Active MAC Address Set Request element.
Rem Tx Address bit=1 indicates the Remove Tx Address Count and Remove Tx Address List fields are present in the Active MAC Address Set Request element.
Rem Rx Address bit=1 indicates the Remove Rx Address Count and Remove Add Rx Address List fields are present in the Active MAC Address Set Request element.
Tx_Salt Present bit, when set=1, indicates the Tx_Salt field is included in the Active MAC Address Set Request element.
Size Tx_MS Present bit, when set=1, indicates the Size Tx Active MAC Address Set field is included in the Active MAC Address Set Request element.
Size Rx_MS Present bit, when set=1, indicates the Size Rx Active MAC Address Set field is included in the Active MAC Address Set Request element.
Add Tx Address Count field specifies the number of MAC addresses that are in the Add Tx Address List field.
Add Tx Address List field contains zero or more MAC addresses to be added from the Rx Active MAC Address Set of the receiving STA.
Add Rx Address Count field specifies the number of MAC addresses that are in the Add Rx Address List field.
Add Rx Address List field contains zero or more MAC addresses to be added from the Tx Active MAC Address Set of the receiving STA.
Remove Tx Address Count field specifies the number of MAC addresses that are in the Remove Tx Address List field.
Remove Tx Address List field contains zero or more MAC addresses to be removed from the Rx Active MAC Address Set of the receiving STA.
Remove Rx Address Count field specifies the number of MAC addresses that are in the Remove Rx Address List field.
Remove Rx Address List field contains zero or more MAC addresses to be removed from the Tx Active MAC Address Set of the receiving STA.

A STA transmitting this element indicates MAC addresses used by the transmitting STA. The MAC addresses included in the (Add/Remove) Tx Address List field correspond to the MAC addresses the transmitting STA may use as Tx addresses (A2) in frames transmitted by the STA. Therefore, the (Add/Remove) Tx Address List includes addresses to be added or removed from the Rx Active MAC Address Set (list of otaMAC_pA2). In the same way, the MAC addresses included in the (Add/Remove) Rx Address List field correspond to the MAC addresses the transmitting STA may use as Rx addresses (A1) in frames received by the STA. Therefore, the (Add/Remove) Rx Address List includes addresses to be added or removed from the Tx Active MAC Address Set (list of otaMAC_pA1).

The Tx_Salt subfield is a value that may be used to anonymize the Sequence Number (or any other field in the frame that is either transmitted in the clear or constant and allows the matching of otaMAC to aaMAC) of frames transmitted by this frame transmitting STA towards the receiving STA. The Size Tx Active MAC Address Set indicates the maximum number of MAC Addresses the Tx Active MAC Address Set of the transmitting STA may contain. The Size Rx Active MAC Address Set indicates the maximum number of MAC Addresses the Rx Active MAC Address Set of the transmitting STA may contain.

In certain embodiments, an Active MAC Address Set Response may not be needed, for example, the Active MAC Address Set Request is simply acknowledged using an ACK reply. In other embodiments, an Active MAC Address Set Response is utilized as described further below.

Active MAC Address Set Response: The Active MAC Address Set Response element is used to signal the result of a management operation over the Active MAC Address Set of the transmitting STA, referred to the aaMAC address of the requesting STA.

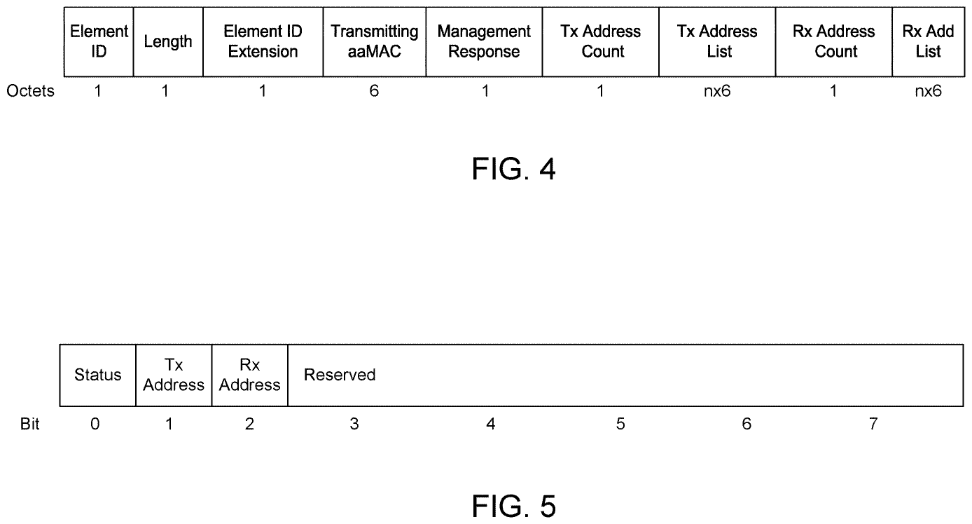

Referring to FIG. 4, an example format for an Active MAC Address Set Response element is shown, and may generally include fields for an Element ID, Length, Element ID Extension, Transmitting aaMAC, Management Response, Tx Address Count, Tx Address List, Rx Address Count and Rx Address List. The Transmitting aaMAC field includes the transmitting aaMAC_pSTA associated to the transmitting STA. Note that the transmitting MAC address (A2) of the frame carrying this element may be already included the Rx Active MAC Address Set (otaMAC_pA2) associated to the transmitting aaMAC (aaMAC_pSTA) on the receiving STA.

Referring to FIG. 5, an example format for the Management Response field of the Active MAC Address Set Response element of FIG. 4 is shown and may include indicators for the following values and purpose:
Status bit is set=0 if the requested operation in the Active MAC Address Set Request element has been successful. The Status bit is set 1 if the requested operation in the Active MAC Address Set Request element has failed.
Tx Address bit indicates the Tx Address Count and Tx Address List fields are present in the Active MAC Address Set Request element.
Rx Address bit indicates the Rx Address Count and Rx Address List fields are present in the Active MAC Address Set Request element.

The Address Count fields of the Response element of FIG. 4 specifies the number of Tx or Rx MAC addresses that are in the respective following Address List fields. The Address List field contains zero or more MAC addresses to indicate the set of MAC addresses to be added or removed from the Active MAC Address Set of the receiving STA.

The STA transmitting Response element of FIG. 4 may provide upon request, the content of its Rx and/or Tx Active MAC Address Set. In this case, the use of the Tx Address and Rx Address bits indicate the Tx and/or Rx Address List field are included in the element. The Tx Address field may provide the list of otaMAC_pA2 addresses associated to the requesting aaMAC_pSTA. The Rx Address field may provide the list of otaMAC_pA1 addresses associated to the requesting aaMAC_pSTA.

As mentioned previously, protection of the Active MAC Address Set Request and Response frames is important. The following embodiments describe example methods of using the Protected Dual of Public Action frames, but other protection such as Self-protected action frames may also be an alternative or additional protection mechanism.

Protected Dual of Public Action Frames: The Active MAC Address Set Request and Active MAC Address Set Response Action frames should be protected, and therefore should be included with Public Action field values defined for Protected Dual of Public Action frames as shown in the following Table 4.

TABLE 4
Public Action Field Values for Protected
Dual of Public Action Frames

| | | IEEE Standard |
|---|---|---|
| Public Action | | Paragraph |
| Field Value | Description | Reference |
| TBD | Active MAC Address Set Request | <To be defined> |
| TBD | Active MAC Address Set Response | <To be defined> |

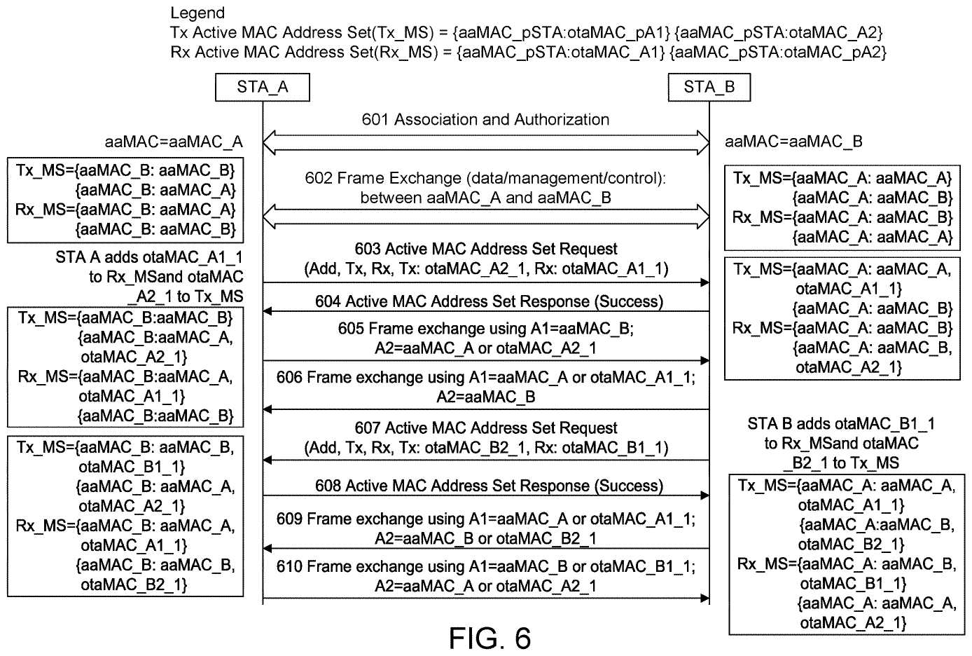

Referring to FIG. 6, a method for protecting MAC address according to certain embodiments is shown and may include the following steps as denoted in the figure:

601. STA_A and STA_B associate (one of STAs A or B may be an AP). Through association both aaMAC addresses are defined, e.g., aaMAC_A for STA_A and aaMAC_B for STA_B.

602. At this point of time the Rx and Tx Active MAC Address Sets are formed by the aaMACs of each of the STAs. Communication uses aaMACs as addresses in the frames following standard mechanisms.

603. STA_A adds two (may be any number) addresses to its Rx and Tx Active MAC Address Sets. otaMAC_A1_1 and otaMAC_A2_1. The former used as receiving address and the later as transmitting address. This is done through the transmission of an Active MAC Address Set Request frame as previously described.

604. STA_B acknowledges the operation and adds otaMAC_A1_1 to its Tx Active MAC Address Set and otaMAC_A2_1 to its Rx Active MAC Address Set. This is acknowledged by the transmission of an Active MAC Address Set Response frame.

605. Frames sent by STA_A now can use as transmitting address either aaMAC_A or otaMAC_A2_1. A1 filtering at STA_B is performed according to the standard since A1 is aaMAC_B, de-anonymization can be performed by looking at the Rx Active MAC Address Set associated to the aaMAC_A.

606. Frames sent by STA_B now can use as receiving address (A1) either aaMAC_A or otaMAC_A1_1. STA_A performs A1 filtering following the procedure described above, by looking at the Rx Active MAC Address Set.

607. STA_B adds two (may be any random number) addresses to its Rx and Tx Active MAC Address Sets. otaMAC_B1_1 and otaMAC_B2_1. The former used as receiving address and the later as transmitting address. This is done through the transmission of an Active MAC Address Set Request frame.

608. STA_A acknowledges the operation and adds otaMAC_B1_1 to its Tx Active MAC Address Set and otaMAC_B2_1 to its Rx Active MAC Address Set. This is acknowledged by the transmission of an Active MAC Address Set Response frame.

609. Frames sent by STA_B now can use as transmitting address either aaMAC_B or otaMAC_B2_1 and receiving address either aaMAC_A or otaMAC_A1_1. A1 filtering at STA_A is performed according to the steps described above, by looking at the Rx Active MAC Address Set. De-anonymization can be performed by looking at the Rx Active MAC Address Set associated to the aaMAC_B.

610. Frames sent by STA_A now can use as receiving address (A1) either aaMAC_B or otaMAC_B1_1 and for transmitting address either aaMAC_A or otaMAC_A2_1. STA_B performs A1 filtering following the procedure described above, by looking at the Rx Active MAC Address Set, and de-anonymization by looking at the Rx Active MAC Address Set.

### Embodiment 2: Use of a Single Set of MAC Addresses for Anonymization/De-Anonymization

In another innovative embodiment, a single set of MAC addresses for anonymization/de-anonymization may be used. The modification of the MAC addresses used in a communication during association, requires mechanisms to maintain a list of MAC addresses that may be used for the receiving and transmitting STAs. Modifying the MAC addresses impacts the A1 filtering and requires a new block in the MAC process, referred to as the Anonymization and De-anonymization block.

Each EP (Enhanced Privacy) STA maintains a record of the aaMAC used in the association (aaMAC_STA). Each EP STA involved in the communication maintains a Tx Active MAC Address Set, and a Rx Active MAC Address Set. The Tx Active MAC Address Set contains the mapping between the aaMAC address of peer STAs (aaMAC_pSTA) and the list of otaMAC addresses advertised by peer STAs for reception/transmission of frames (list of otaMAC_pA1). This list of addresses is also used as MAC addresses to be used as Tx address (A2) in received frames (list of otaMAC_pA2)

The Rx Active MAC Address Set includes the list of addresses the STA uses for receiving frames from peer STAs (list of otaMAC_A1). This list of addresses is also used as MAC addresses to be used as Tx address (A2) in transmitted frames (list of otaMAC_A2). The Tx or Rx Active MAC Address Set therefore is dynamic and may change during a communication or association.

The anonymization process of a frame, given Tx and Rx Active MAC Address Sets stored in a STA, starts by the STA processing a MDPU to be transmitted. It first compares the Rx (A1) address on the MPDU with the aaMAC_pSTA stored in the Tx Active MAC Address Set. Once found, the transmitting STA may choose among all the otaMAC_pA1 addresses in the Tx Active MAC Address Set and all the otaMAC_A2 addresses in the Rx Active MAC Address Set. The MPDU is then modified, exchanging the A1 and A2 addresses by the newly selected otaMAC_pA1 and otaMAC_A2 and continue processing.

The receiving process starts by the STA receiving a unicast frame and performing A1 filtering. The receiving STA compares the A1 address in the received frame to the list of otaMAC_A1 addresses stored in the Rx Active MAC Address Set. If found, processing may continue, otherwise the frame should be discarded. After checking A1, the EP receiving STA may check for the received A2 address, comparing it to the otaMAC_pA2 addresses stored in the Tx Active MAC Address Set. If found, the frame is modified, exchanging the A1 address by the aaMAC_pSTA of the transmitting STA (stored in the Rx Active MAC Address Set) and the A2 by the receiving aaMAC_STA.

Messages to Manage the Active MAC Sets for Use with a Single Set of MAC Addresses for Anonymization/De-Anonymization

This innovative embodiment discusses frame formats to indicate the addition or removal of MAC addresses into the pool of active MAC addresses. The following specific format is an example of a possible implementation, implementations where similar information is carried in other kind of frames or fields may also be possible. The innovations herein may be standardized for use by STAs in wireless networks. As such, the innovations described below may be included in a wireless specification such as IEEE 802.11bi or other wireless specification.

Initially, an Action frame is defined, referred to as, the Active MAC Address Set Management Request frame format. As with previous embodiments, this frame enables the addition, removal or request for the complete Active MAC Address Set.

New public action frames are defined as shown in Table 5 below:

TABLE 5
Public Action Frames for Active MAC Address
Set Management Request and Response

| Public Action | |
|---|---|
| Field Value | Description |
| TBD | Active MAC Address Set Management Request |
| TBD | Active MAC Address Set Management Response |

As described in previous embodiments hereinabove, these frames are defined as Protected Public Action frames which assist in the protection for frames exchanging the MAC sets. A different implementation may define them as other type of Protected Action frame. For example, a newly created category for protected Enhanced Privacy Action frames herein may be referred to as Robust Action frames (non-public).

Active MAC Address Set Management Request frame format. The Active MAC Address Set Management Request frame is sent to a STA to manage the Active MAC Address Set associated to the transmitting STA stored in the receiving STA. The Action field of an Active MAC Address Set Management Request frame may include the information shown in the following Table 6.

TABLE 6
Action Field Information for Active MAC
Address Set Management Request Frame

| Order | Information |
|---|---|
| 0 | Category |
| 1 | Public Action |
| 2 | Dialog Token |
| 3 | Active MAC Address Set Request |

An Active MAC Address Set Request field is newly defined for embodiments described herein.

Active MAC Address Set Management Response Frame Format: The Active MAC Address Set Management Response frame is replied to a STA to indicate the status of a request for the managing of its Active MAC Address Set. The Action field of an Active MAC Address Set Management Response frame may include the information shown in the following Table 7.

TABLE 7
Action Field Information for Active MAC
Address Set Management Response Frame

| Order | Information |
|---|---|
| 0 | Category |
| 1 | Public Action |
| 2 | Dialog Token |
| 3 | Active MAC Address Set Response |

The Active MAC Address Set Response field is newly defined for the present embodiments. The information carried in the Active MAC Address Set element may be implemented in a different field.

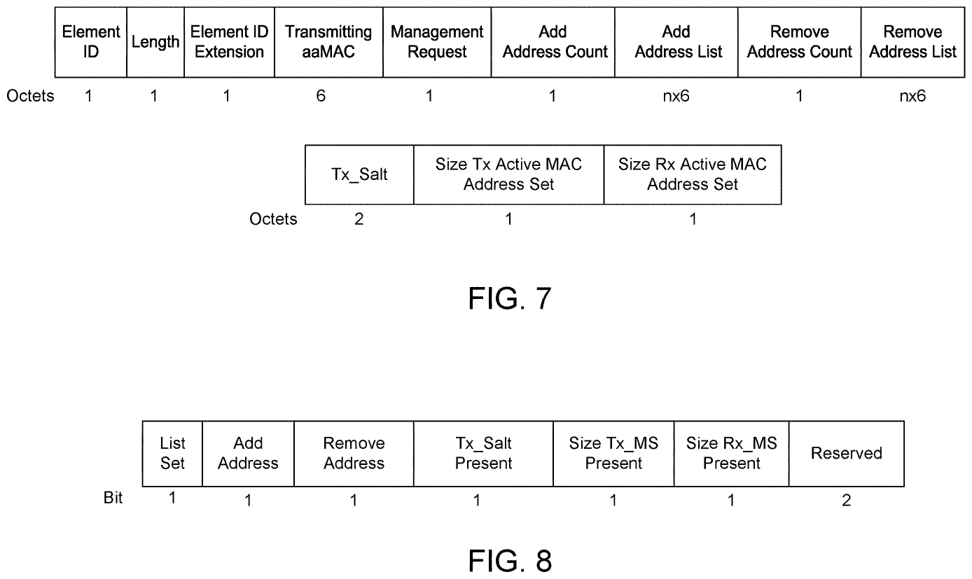

Active MAC Address Set Request: The Active MAC Address Set Request element is used to signal the desire to include, remove or list the MAC addresses belonging to the dot11ActiveMACAddressesSet associated to the transmitting aaMAC and stored in the receiving STA. FIG. 7 shows an example format which may include fields for Element ID, Length and Element ID Extension. Active MAC Address Set Request may also include a Transmitting aaMAC field that includes the transmitting aaMAC_pSTA of the transmitting STA. Note that the transmitting MAC address (A2) of the frame carrying this element may be already included in the Tx Active MAC Address Set associated to the transmitting aaMAC (aaMAC_pSTA) on the receiving STA.

Referring to FIG. 8, an example format for the Management Request field of the Active MAC Address Set Request element shown in FIG. 7. The Management Request field may provide the following indications:
List Set bit, when set=1, indicates the request to list the addresses in the Active MAC Address Sets. Otherwise indicates the transmitter is not requesting the receiver to list its Active MAC Address Sets.
Add Address bit=1 indicates the Add Address Count and Add Address List fields are present in the Active MAC Address Set Request element.
Remove Address bit=1 indicates the Remove Address Count and Remove Address List fields are present in the Active MAC Address Set Request element.
Tx_Salt Present bit, when set=1, indicates the Tx_Salt field is included in the Active MAC Address Set Request element.
Size Tx_MS Present bit, when set=1, indicates the Size Tx Active MAC Address Set field is included in the Active MAC Address Set Request element.
Size Rx_MS Present bit, when set=1, indicates the Size Rx Active MAC Address Set field is included in the Active MAC Address Set Request element.

The Address Count field of Active MAC Address Set Request element in FIG. 7 specifies the number of MAC addresses that are in the Address List field. The Address List field contains zero or more MAC addresses to indicate the set of MAC addresses to be added or removed from the Active MAC Address Set of the receiving STA. The Tx_Salt subfield is a value that may be used to anonymize the Sequence Number (or any other field in the frame that is either transmitted in the clear or constant and allows the matching of otaMAC to aaMAC) of frames transmitted by this frame transmitting STA towards the receiving STA. The Size Tx Active MAC Address Set indicates the maximum number of MAC Addresses the Tx Active MAC Address Set of the transmitting STA may contain and the Size Rx Active MAC Address Set indicates the maximum number of MAC Addresses the Rx Active MAC Address Set of the transmitting STA may contain.

In some embodiments, an Active MAC Address Set Response is not uses, as the Request may simply be acknowledged by an ACK from the STA receiving the Request element. In other embodiments, an Active MAC Address Set Response element is used to signal the result of a management operation over the Active MAC Address Set of the transmitting STA, referred to the aaMAC address of the requesting STA.

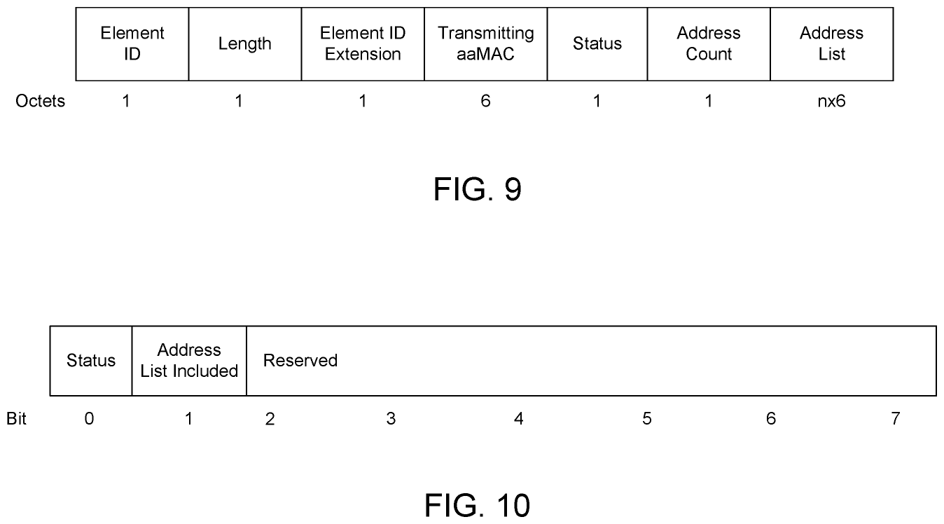

Active MAC Address Set Response: FIG. 9 shows and example format for an Active MAC Address Set Response element of one embodiment, which includes Element ID, Length and Element ID Extension fields, a Transmitting aaMAC field, a Status field, an Address Count field and an Address List field. The Transmitting aaMAC field includes the transmitting aaMAC associated to the transmitting STA. Note that the transmitting MAC address (A2) of the frame carrying this element may be already included in the Tx Active MAC Address Set associated to the transmitting aaMAC (otaMAC_pA2) on the receiving STA.

The Status field may have an example format shown in FIG. 10. The Status bit is set=0 if the requested operation in the Active MAC Address Set Request element has been successful and the Status bit is set=1 if the requested operation in the Active MAC Address Set Request element has failed. Status field may also include an Address List Included bit, when set=1, indicates the Address Count field and the Address List field are included in the Active MAC Address Set Response element. If the Address List Included bit is set=0, those fields may not be included in the Response element.

The Address Count field of Response element in FIG. 9 specifies the number of MAC addresses that are in the Address List field. The Address List field contains zero or more MAC addresses to indicate the set of MAC addresses to be added or removed from the Active MAC Address Set of the receiving STA. The STA transmitting the an Active MAC Address Set Response element may provide upon request the content of its Tx Active MAC Address Set for the given aaMAC_pSTA.

As with protection of Management Request and Response frame embodiments, Protection of the Active MAC Address Set Request and Response frames is important. Example methods of protecting Active MAC Address Set Request and Response frames may use the Protected Dual of Public Action frames. Alternatively, or in addition, other protection mechanisms, such as Self-protected action frames may be utilized.

Protected Dual of Public Action Frames: In order to protect the Active MAC Address Set Request and Active MAC Address Set Response Action frames using Protected Dual of Public Action frames, Public Action field values may be defined for Protected Dual of Public Action frames as shown in Table 8 below.

TABLE 8
Public Action field values defined for
Protected Dual of Public Action frames

| | | IEEE Standard |
|---|---|---|
| Public Action | | Paragraph |
| Field Value | Description | Reference |
| TBD | Active MAC Address Set Request | <To be defined> |
| TBD | Active MAC Address Set Response | <To be defined> |

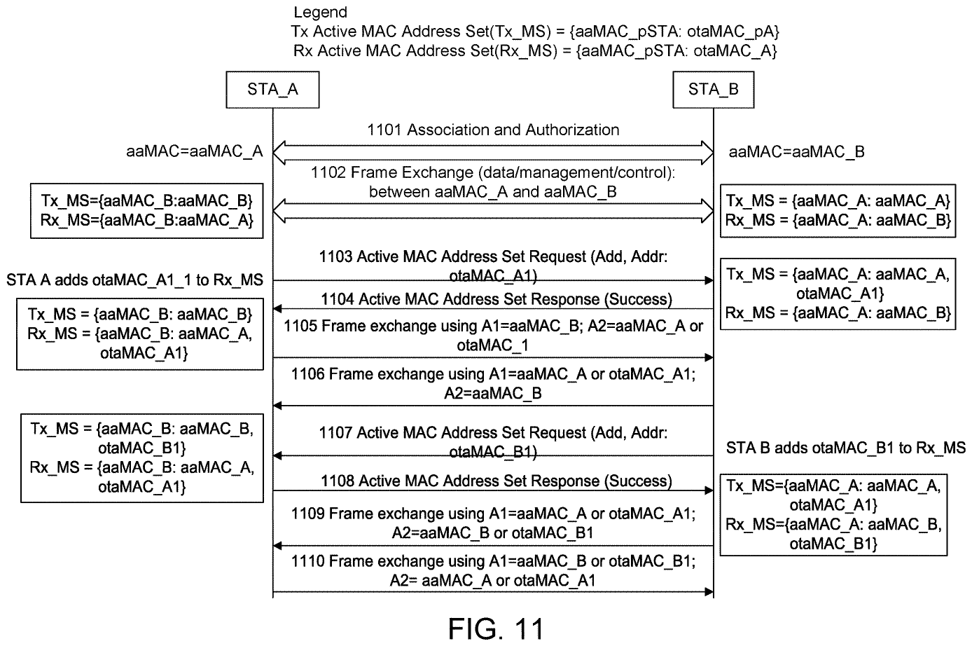

Referring to FIG. 11, a method of protecting Active MAC Address Set Request and Responses frames may include the steps as shown in the figure:
1101. STA_A and STA_B associate (one of them may be an AP). Through association both aaMAC addresses are defined, aaMAC_A for STA_A and aaMAC_B for STA_B.
1102. At this point of time the Rx and Tx Active MAC Address Sets are formed by the aaMACs of each of the STAs. Communication using aaMACs as addresses in the frames following standard mechanisms.
1103. STA_A adds (may be random) an address to its Rx Active MAC Address Sets. otaMAC_A1. The address may be used as receiving address and as transmitting address. This is done through the transmission of an Active MAC Address Set Request frame.
1104. STA_B acknowledges the operation and adds otaMAC_A1 to its Tx Active MAC Address Set. This is acknowledged by the transmission of an Active MAC Address Set Response frame.
1105. Frames sent by STA_A now can use as transmitting address either aaMAC_A or otaMAC_A1. A1 filtering at STA_B is performed according to standard since A1 is aaMAC_B, de-anonymization can be performed by looking at the Rx and Tx Active MAC Address Sets.
1106. Frames sent by STA_B now can use as receiving address (A1) either aaMAC_A or otaMAC_A1. STA_A performs A1 filtering following the procedure described above, by looking at the Rx Active MAC Address Set and de-anonymization by looking at the Rx and Tx Active MAC Address Sets.
1107. STA_B adds (may be random) an address to its Rx and Active MAC Address Sets. otaMAC_B1. The address may be used as receiving address and as transmitting address. This is done through the transmission of an Active MAC Address Set Request frame.
1108. STA_A acknowledges the operation and adds otaMAC_B1 to its Tx Active MAC Address Set. This is acknowledged by the transmission of an Active MAC Address Set Response frame.
1109. Frames sent by STA_B now can use as transmitting address either aaMAC_B or otaMAC_B1 and receiving address either aaMAC_A or otaMAC_A1. A1 filtering at STA_A is performed according to the steps described above, by looking at the Rx Active MAC Address Set. De-anonymization can be performed by looking at the Rx and Tx Active MAC Address Set associated to the aaMAC_B.
1110. Frames sent by STA_A now can use as receiving address (A1) either aaMAC_B or otaMAC_B1 and for transmitting address either aaMAC_A or otaMAC_A1. STA_B performs A1 filtering following the procedure described above, by looking at the Rx Active MAC Address Set and de-anonymization by looking at the Rx and Tx Active MAC Address Sets.

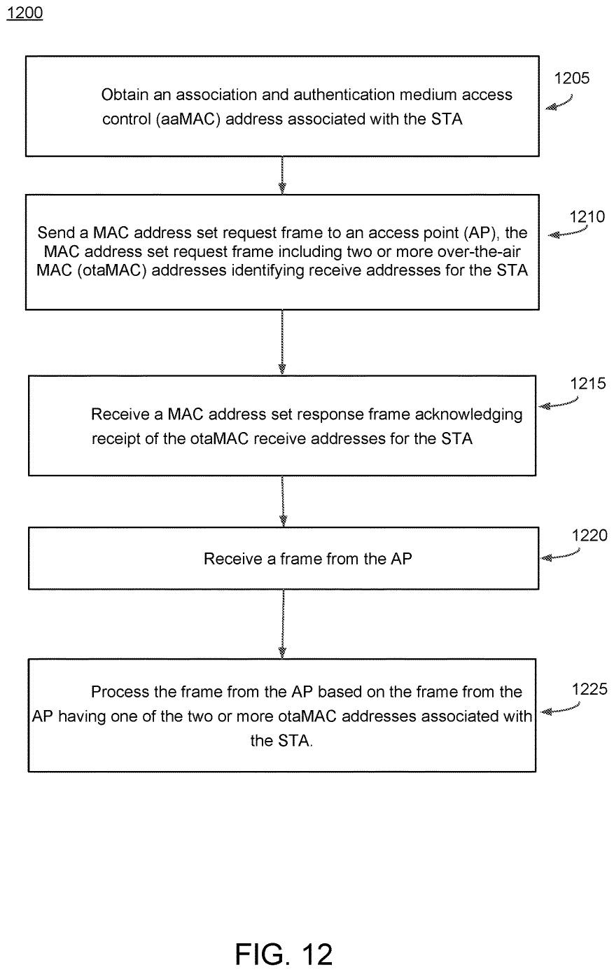

FIG. 12 is a flow diagram of an example method using features of FIG. 11. At 1205, a wireless STA, such as a WTRU operating in a wireless network, obtains information that establishes an association and authentication MAC (aaMAC) address associated with the STA. The aaMAC address corresponds to the MAC address used for the association and authentication process between the AP and the STA and is the one indexed in the RSNA (Robust Secure Network Association). This MAC address is used to set up the RSNA, for routing traffic to the STA on the DS network segment and it is also the one used for mobility related operations such as Fast Transition mechanisms.

At 1210, the STA sends a MAC address set request frame to an access point (AP), the MAC address set request frame including two or more over-the-air MAC (otaMAC) addresses identifying receive addresses for the STA. The otaMAC is used to keep private the aaMAC of the STA.

At 1215, the STA receives a MAC address set response frame acknowledging receipt of the otaMAC receive addresses for the STA. At this point, the STA may receive frames using the otaMAC addresses. At 1220, the AP may send a wireless communication message (a frame of information) to the STA which the STA receives. At 1230, the STA process the received frame of information from the AP. The processing of the received frame is based on the frame from the AP having one of the two or more otaMAC addresses associated with the STA. Assuming the received frame from the AP uses one of the two or more otaMAC addresses, then the STA accepts the frame as intended for the STA.

The STA processes the received frame from the AP by filtering an A1 receive address of the STA to determine if the address other than the aaMAC address of the STA is one of the two or more otaMAC addresses is associated with the STA. In one aspect, the STA receives the frame from the AP from a second STA which is communicating to the STA via the AP. In one embodiment, the STA, second STA, and the AP have established different respective otaMAC address and each performs A1 filtering of addresses on received frames.

In another aspect, the STA may mask frame sequence numbers of the MAC address set request frame so as to further improve privacy of communication by obscuring the sequence of frames as perceived by a tracking mechanism. In addition, the MAC address set request frame and the MAC address response frame are a protected dual of public action frames.

### Embodiment 3: Modification of Sequence Number

In another innovative embodiment, modification of the sequence number (or any other field in the frame that is either transmitted in the open or is constant and allows the matching of otaMAC to aaMAC) may be performed. The innovations herein may be standardized for use by STAs in wireless networks. As such, the innovations described below may be included in a wireless specification such as IEEE 802.11bi or other wireless specification.

To support enhanced privacy, in addition to the A1 and A2 anonymization, any parameter that is transmitted in the clear or remains constant across transmission should be anonymized. Parameters to be considered for anonymization may include the sequence control, sequence number, QoS control, HT control and the CCMP header. In this embodiment the sequence number is used for example, although such an approach may be used for the rest of the fields.

The sequence number (SN), in general, is a 12-bit field which contains a sequential number of one the 7-sets of sequence numbers defined in Table 10-5 of IEEE 802.11REVme/D2.0. As defined in IEEE 802.11aq, the sequence number is randomly selected every time the MAC address changes (pre-association MAC address modification).

To achieve an enhanced privacy, a sequence number may be computed specific for each transmission and reception MAC Address tuple (A1, A2) used in the previous embodiments. This SN may be modified any time the communicating STAs desires, e.g., periodically or according to a randomization pattern.

The mechanism is based on a Salt parameter each STA in the communication may exchange, as follows. As defined in previous embodiments, each STA stores a Rx and a Tx Active MAC Address Sets. In this embodiment the content of the Tx/Rx Active MAC Address Sets may be extended to include a Salt parameter (Tx_Salt is stored in the Tx Active MAC Address Set and Rx_Salt is stored in the Rx Active MAC Address Set) that is exchanged and used by the STAs. The transmitting STA sends the Tx_Salt to the receiving STA through the Active MAC Address Request frame. The receiving STA stores the received Tx_Salt as the Rx_Salt in its Rx Active MAC Address Set. Therefore, for two given STAs communicating, the Tx_Salt may be used to anonymize the SN number on transmission, and used as Rx_Salt for de-anonymization of the SN in reception.

For a transmitting STA, the SN used in frames may be computed as follows: First, a Hash function of the otaMAC addresses in the frame together with the Tx_Salt parameter stored in the Tx Active MAC Address Set is generated: SN_salt=Hash (otaMAC_A1, otaMAC_A2, Tx_Salt); Second, the new SN to be added to the frame is computed by performing the XOR operation of the original SN and the SN_salt: SN_new=SN XOR SN_salt.

On reception, the STA computes first the SN_salt by using the Rx_Salt in the Rx Active MAC Address Set: SN_salt=Hash (otaMAC_A1, otaMAC_A2, Rx_Salt) and later is able to obtain the original SN by performing the XOR operation: SN_original=SN_new XOR SN_salt.

The Tx_Salt and Rx_Salt used in the communication between a transmitting STA (STA1) and receiving STA (STA2) may be different from the one used between a transmitting STA (STA2) and receiving STA (STA1). In addition to the foregoing mechanism, there may be simpler mechanisms that can also be applied to such a scenario. One example includes using a random offset associated to each of the otaMACs and added to the Sequence Number. A random mask is associated to each of the otaMACs and XOR to the Sequence Number. Other potential functions may be used to mask the SN based on the otaMACs and element exchanges discussed herein.

Aspects of the present disclosure provide mechanisms, devices and message formats to enable A1 filtering while communicating STAs change their MAC addresses. In addition, and in order to improve the privacy, aspects of this disclosure enable hiding the Sequence Number (SN) of the frame, for example, obfuscating the SN based on the set of addresses used in the frame.

Aspects of the embodiments hereinabove relate to an association and authentication MAC (aaMAC) address, which corresponds to a MAC address used for the association and authentication process between the AP and the STA. In one aspect, the aaMAC address is one indexed in a robust secure network association (RSNA) procedure. This MAC address is used to set up the RSNA, for routing traffic to the STA on the distribution system (DS) network segment and it is also used for mobility related operations such as fast transition procedures.

Additional aspects of the embodiments discussed hereinabove relate to an over-the-air MAC (otaMAC) addresses used in frames transmitted over the air. For individually addressed frames involving a distribution system (DS), where the To DS bit is set=1 and the From DS bit is set=0, the otaMAC is transmitted as the Address-2. For individually addressed frames where To DS bit is set=0 and From DS bit is set=1, the otaMAC is transmitted as the Address-1. An advantage of using the otaMAC is to keep private the aaMAC of the STA and may potentially be changed on a packet basis.

Overall, the disclosure hereinabove provides mechanisms and message formats to enable A1 filtering while communicating STAs change their MAC addresses. In addition, and in order to improve the privacy, the description also proposes a mechanism to hide the Sequence Number of the frame, obfuscating it based on the set of addresses used in the frame.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

1. A method performed by a wireless station (STA) to use over-the-air MAC (otaMAC) addresses, the method comprising:
obtaining an association and authentication medium access control (aaMAC) address associated with the STA;
sending a MAC address set request frame to an access point (AP), the MAC address set request frame including two or more otaMAC addresses identifying receive addresses for the STA;
receiving a MAC address set response frame acknowledging receipt of the otaMAC receive addresses for the STA;
receiving a frame from the AP;
processing the frame from the AP based on the frame from the AP having one of the two or more otaMAC addresses associated with the STA.

2. The method of claim 1, wherein processing the frame from the AP is preceded by filtering an A1 receive address of the STA to determine if the address other than the aaMAC address of the STA is one of the two or more otaMAC addresses is associated with the STA.

3. The method of claim 1, wherein receiving a frame from the AP comprises receiving a frame from the AP having an address other than the aaMAC address of the STA.

4. The method of claim 3, wherein receiving a frame from the AP having an address other than the aaMAC address of the STA comprises receiving a frame from a second STA communicating via the AP.

5. The method of claim 4, wherein the STA, second STA, and AP have established different respective otaMAC address and each performs A1 filtering of addresses on received frames.

6. The method of claim 1, further comprising:
masking frame sequence numbers of the MAC address set request frame.

7. The method of claim 1, wherein the MAC address set request and the MAC address response frame are a protected dual of public action frames.

8. The method of claim 1, obtaining an association and authentication medium access control (aaMAC) address associated with the STA comprises obtaining the aaMAC address from any of a provision of the aaMAC via the AP or a provision via a STA configuration.

9. A wireless station (STA) comprising circuitry, including a transmitter, a receiver, a processor, and memory, the STA configured to:
obtain an association and authentication medium access control (aaMAC) address associated with the STA;
send a MAC address set request frame to an access point (AP), the MAC address set request frame including two or more over-the-air MAC (otaMAC) addresses identifying receive addresses for the STA;
receive a MAC address set response frame acknowledging receipt of the otaMAC receive addresses for the STA;
receive a frame from the AP;
process the frame from the AP based on the frame from the AP having one of the two or more otaMAC addresses associated with the STA.

10. The wireless STA of claim 9, wherein the STA processes the frame from the AP is by filtering an A1 receive address of the STA to determine if the address other than the aaMAC address of the STA is one of the two or more otaMAC addresses is associated with the STA.

11. The wireless STA of claim 9, wherein the STA receives a frame from the AP having an address other than the aaMAC address of the STA.

12. The wireless STA of claim 11, wherein the STA receives the frame from the AP from a second STA communicating via the AP.

13. The wireless STA of claim 12, wherein the STA, second STA, and AP have established different respective otaMAC address and each performs A1 filtering of addresses on received frames.

14. The wireless STA of claim 9, wherein the wireless STA is further configured to: mask frame sequence numbers of the MAC address set request frame.

15. The wireless STA of claim 9, wherein the MAC address set request frame and the MAC address response frame are a protected dual of public action frames.

16. The wireless STA a claim 9, wherein the wireless STA is a wireless transmit/receive unit (WTRU).

17. The wireless STA of claim 9, wherein the STA obtains a aaMAC address from any of a provision of the aaMAC via the AP or a provision via a STA configuration.

18. A non-transitory computer-readable storage medium embodying instructions, which when executed by a computer, cause the computer to perform the method of claim 1.
